(19) United States
(12) Patent Application Publication
(10) Pub. No.: US 2017/0245269 A1
(43) Pub. Date: Aug. 24, 2017

(54) BASE STATION AND SCHEDULING METHOD

(71) Applicant: FUJITSU LIMITED, Kawasaki-shi (JP)

(72) Inventors: Takato Ezaki, Yokohama (JP); Tomoyuki Abe, Yokohama (JP)

(73) Assignee: FUJITSU LIMITED, Kawasaki-shi (JP)

(21) Appl. No.: 15/420,763

(22) Filed: Jan. 31, 2017

(30) Foreign Application Priority Data
Feb. 24, 2016 (JP) 2016-033453

(51) Int. Cl. H04W 72/04; H04W 72/12

(52) U.S. Cl. CPC H04W 72/0446; H04W 72/12; H04W 88/08

(57) ABSTRACT

Provided is a base station including a communication processor configured to perform a communication process, a first scheduler configured to allocate radio resources to one or more first wireless communication terminals that perform wireless communication through the communication process performed by the communication processor, a second scheduler configured to allocate radio resources to one or more second wireless communication terminals that perform wireless communication through the communication process performed by the communication processor, and a controller configured to perform control such that a first time interval in which the first scheduler allocates the radio resources to the one or more of first wireless communication terminals is different from a second time interval in which the second scheduler allocates the radio resources to the one or more of second wireless communication terminals.

### CROSS-REFERENCE TO RELATED APPLICATION

This application is based upon and claims the benefit of priority of the prior Japanese Patent application No. 2016-33453, filed on Feb. 24, 2016, the entire contents of which are incorporated herein by reference.

### FIELD

The embodiments discussed herein are directed to a base station and a scheduling method used for wireless communication.

### BACKGROUND

There are several techniques related to dynamic switching and a simultaneous operation of a plurality of baseband processors. In these techniques, a plurality of baseband processing devices serving as hardware are used, and a plurality of baseband processing devices correspond to, for example, a plurality of sectors or a plurality of areas, respectively.

Patent Literature 1: JP 2003-179955 A

Patent Literature 2: JP 2004-336112 A

Patent Literature 3: JP 2006-050545 A

Patent Literature 4: JP 2009-38692 A

Patent Literature 5: JP 2009-55119 A

Patent Literature 6: JP 2011-66528 A

Patent Literature 7: JP 2012-85155 A

Patent Literature 8: WO 2006/137495 A

### SUMMARY

When a plurality of sets of hardware for communication process is used, it is necessary to perform scheduling consistently. For this reason, when a scheduler controlling radio resources for a terminal is switched to another scheduler, a process of transferring data related to scheduling between the schedulers is performed. At this time, it is necessary to stop processes of a scheduler operated in hardware of a transfer source of the data and/or a scheduler operated in hardware of a transfer destination. Thus, a communication process is stopped until the processes of the schedulers restart, and thus communication is delayed.

According to an aspect of the embodiments, a base station includes a communication processor, a first scheduler, a second scheduler, and a controller. The communication processor is configured to perform a communication process. The first scheduler is configured to allocate radio resources to one or more first wireless communication terminals that perform wireless communication through the communication process of the communication processor. The second scheduler is configured to allocate radio resources to one or more second wireless communication terminals that perform wireless communication through the communication process of the communication processor. The controller is configured to perform control such that a first time interval in which the first scheduler allocates the radio resources to the one or more of first wireless communication terminals is different from a second time interval in which the second scheduler allocates the radio resources to the one or more of second wireless communication terminals.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration of a wireless communication system including a base station according to an embodiment;

FIG. 2 is a functional block diagram of a base station according to an embodiment;

FIG. 3 is a diagram illustrating an example of a relation between a frame and a subframe;

FIG. 4 is a diagram illustrating an example of a state in which a plurality of schedulers included in a base station according to an embodiment operate in a time division manner;

FIG. 5 is a flowchart illustrating a process of a base station according to an embodiment;

FIG. 6 is a flowchart illustrating a process of a base station according to an embodiment;

FIG. 7 is a diagram illustrating a hardware configuration of a base station according to an embodiment;

FIG. 8 is a flowchart illustrating a process of a base station according to an embodiment;

FIG. 9 is a diagram illustrating an example of a data structure referred to when a plurality of schedulers included in a base station according to an embodiment operate in a time division manner;

FIG. 10 is a flowchart illustrating a process of a base station according to an embodiment;

FIG. 11 is a flowchart illustrating a process of a base station according to an embodiment;

FIG. 12 is a flowchart illustrating a process of a base station according to an embodiment;

FIG. 13 is a flowchart illustrating a process of a base station according to an embodiment;

FIG. 14 is a flowchart illustrating a process of a base station according to an embodiment;

FIG. 15 is a diagram illustrating a hardware configuration when a base station according to an embodiment is implemented by network functions virtualization (NFV);

FIG. 16 is a flowchart illustrating a process of a base station according to a comparative example; and

FIG. 17 is a flowchart illustrating a process of a base station according to a comparative example.

### DESCRIPTION OF EMBODIMENT(S)

Hereinafter, exemplary embodiments of the present invention will be described with reference to the appended drawings. The following embodiments are merely examples and not intended to exclude the application of various modifications or techniques that are not explicitly described below. In other words, various modifications of the present embodiments can be made within the scope not departing from the gist thereof. Further, the drawings are not limited to having only components illustrated in the drawings and may include other functions or the like. In the description of the drawings, the same reference numerals denote the same parts, and repeated explanation thereof may be omitted in this specification.

### First Embodiment

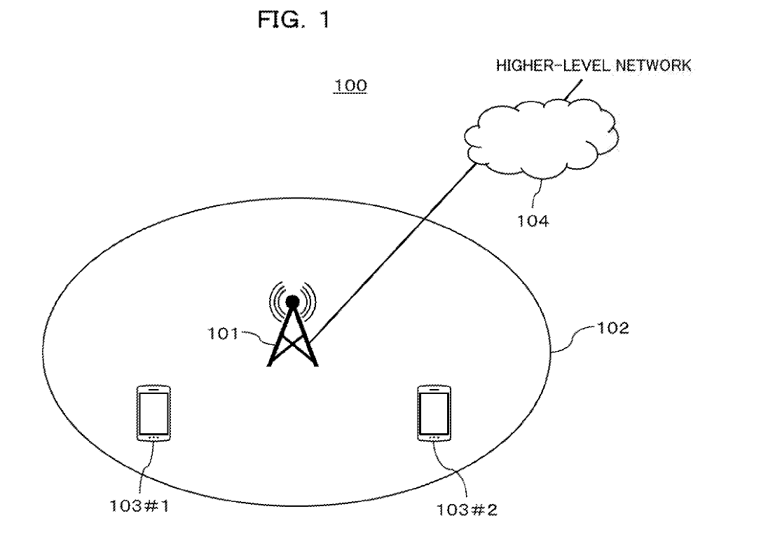

FIG. 1 is a diagram illustrating an overall configuration of a wireless communication system 100 including a base station according to an embodiment. The wireless communication system 100 includes a base station 101, wireless communication terminal 103#1 and 103#2, and a core network 104 as illustrated in FIG. 1. Each of the wireless communication terminals 103#1 and 103#2 enters a state capable of performing communication with the base station 101 when it is located within a wireless area 102 formed by the base station 101. Further, since the base station 101 is connected to the core network 104, the wireless communication terminals 103#1 and 103#2 are able to perform communication with the core network 104. When the core network 104 is connected to a higher-level network, the wireless communication terminals 103#1 and 103#2 are able to perform communication with the higher-level network as well. The wireless communication terminal is also abbreviated as a “terminal.”

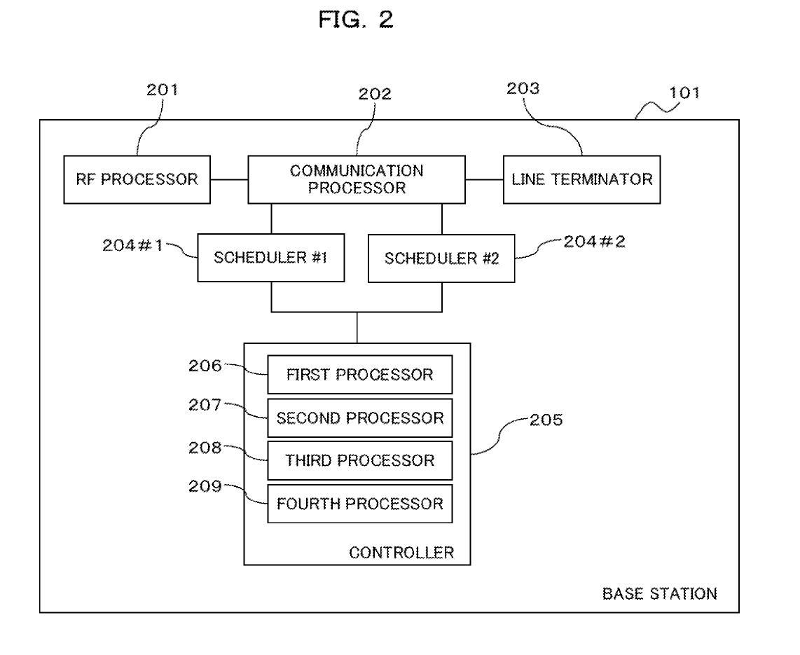

FIG. 2 is a functional block diagram of the base station 101. The base station 101 includes a radio frequency (RF) processor 201, a communication processor 202, a line terminator 203, a scheduler #1 (204#1), a scheduler #2 (204#2), and a controller 205.

The controller 205 may include one or more of a first processor 206, a second processor 207, a third processor 208, and a fourth processor 209 as illustrated in FIG. 2. The first processor 206 will be mainly described in a second embodiment, the second processor 207 and the third processor 208 will be mainly described in a fourth embodiment, and the fourth processor 209 will be mainly described in a fifth embodiment.

The RF processor 201 performs wireless communication with the wireless communication terminals 103#1 and 103#2. For example, the RF processor 201 down-converts a wireless signal received from the terminal 103#1 or 103#2, converts the signal into a digital signal, and outputs the digital signal to the communication processor 202. The RF processor 201 converts a baseband signal output from the communication processor 202 into an analog signal, up-converts the analog signal, and transmits the signal to the terminal 103#1 or 103#2.

The communication processor 202 performs a communication process using either or both of a physical channel and a logical channel. In other words, the communication processor 202 processes a communication layer that deals with either or both of the physical channel and the logical channel. The physical channel may correspond to the layer 1. The logical channel may correspond to the layer 2 and a higher layer. For example, the communication processor 202 performs modulation of data of the layer 2, demodulation of data of the layer 2, encoding of data of the layer 2, and decoding of data of the layer 2, pre-coding, multiplexing, and demultiplexing as processes of the layer 1. For example, the communication processor 202 performs a protocol process based on radio link control (RLC) and media access control (MAC) as processes of the layer 2.

The line terminator 203 is a communication interface with an external device. For example, the line terminator 203 may be used as an S1 interface for communication between the core network 104 and the base station 101. Alternatively, the line terminator 203 may be used as an X2 interface for communication with other base stations 101. For example, the line terminator 203 receives data that is transmitted from the core network 104 to each of the base station 101, the terminal 103#1 and the terminal 103#2, and transmits data that is transmitted from each of the base station 101, the terminal 103#1 and the terminal 103#2 to the core network or the higher-level network.

The scheduler #1 (204#1) allocates radio resources to one or more wireless communication terminals 103. The scheduler #2 (204#2) allocates radio resources to one or more wireless communication terminals 103. Here, the wireless communication terminal 103 may perform wireless communication using the communication layer processed by the communication processor 202. The wireless communication terminal 103 to which the radio resources are allocated by the scheduler #1 (204#1) may be classified as a first wireless communication terminal, and the wireless communication terminal 103 to which the radio resources are allocated by the scheduler #2 (204#2) may be classified as a second wireless communication terminal. The first wireless communication terminal may be different from the second wireless communication terminal. In other words, the schedulers #1 (204#1) and #2 (204#2) allocate radio resources to one or more first wireless communication terminals and one or more second wireless communication terminals, respectively. In other words, each of the schedulers #1 (204#1) and #2 (204#2) allocates radio resources of various kinds of channels. For example, each of the schedulers #1 (204#1) and #2 (204#2) allocates radio resources to the terminal 103#1 or 103#2 according to a radio resource allocation request transmitted from the wireless communication terminal 103#1 or 103#2. Each of the schedulers #1 (204#1) and #2 (204#2) allocates radio resources that are used by the communication processor 202 to transmit data or a signal to the wireless communication terminal 103#1 or 103#2 to the wireless communication terminal 103#1 or 103#2.

In the present embodiment, a common set of a set of wireless communication terminals to which the radio resources are allocated by the scheduler #1 (204#1) and a set of wireless communication terminals to which the radio resources are allocated by the scheduler #2 (204#2) may be an empty set. In other words, when the radio resources are allocated to the wireless communication terminal 103#1 by the scheduler #1 (204#1), the scheduler #2 (204#2) may not allocate radio resources to the wireless communication terminal 103#1. Similarly, when the radio resources are allocated to the wireless communication terminal 103#2 by the scheduler #2 (204#2), the scheduler #1 (204#1) may not allocate radio resources to the wireless communication terminal 103#2.

Further, an allocation of radio resources to a terminal by a certain scheduler may be understood as indicating that the scheduler is responsible for the terminal. Thus, there may not be terminal that belongs to both of a group of wireless communication terminals for which the scheduler #1 (204#1) is responsible and a group of wireless communication terminals for which the scheduler #2 (204#2) is responsible.

In FIG. 2, two schedulers #1 (204#1) and #2 (204#2) are illustrated. The present disclosure is not limited to an example in which the base station 101 includes two schedulers. The number of schedulers with which the base station 101 is equipped may be arbitrary. For example, the base station 101 may be equipped with an arbitrary number of schedulers such as 4, 5, 8, 11, 16, 21, or 32 schedulers. The function of the scheduler may be implemented in a card or a substrate as hardware attachable to the base station 101. The number of schedulers may be dynamically changed with attachment or detachment of the card or the substrate when the base station 101 is in an operation state. The number of schedulers may be dynamically changed as a scheduler is formed as a thread or a process operating in a computer by software.

The functions of the RF processor 201, the communication processor 202 and the line terminator 203 may be implemented in a card or a substrate as hardware attachable to the base station 101. The number of RF processors 201, the number of communication processors 202, or the number of line terminators 203 may be dynamically changed with attachment or detachment of the card or the substrate when the base station 101 is in an operation state.

The controller 205 controls operations of the schedulers included in the base station 101 (the schedulers #1 (204#1) and #2 (204#2) in FIG. 2). For example, the controller 205 allocates transmission time intervals (TTIs) which are time intervals at which radio resources are allocated to a terminal for which each scheduler is responsible to each scheduler as will be described below. Each scheduler allocates radio resources at the allocated TTIs.

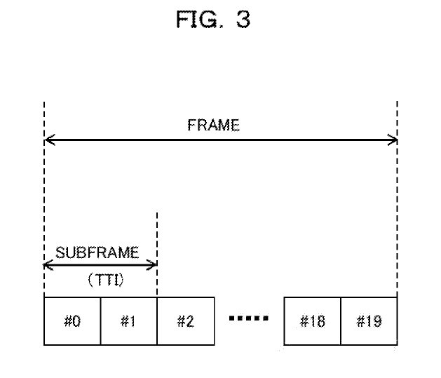

The TTI corresponds to a subframe in an example of long term evolution (LTE). In the example of LTE, a subframe may include two slots which are temporally consecutive (for example, #0 and #1) as illustrated in FIG. 3. In other words, the TTI allocated to each scheduler may be a time interval having a length corresponding to a subframe or may be a time interval corresponding to two slots which are temporally consecutive. A frame is configured with a predetermined number of subframes that are temporally consecutive. In FIG. 3, a frame is configured with 10 consecutive subframes. The number of consecutive subframes constituting a frame may be arbitrarily designated. The following description will proceed with an example in which a frame is configured with 10 consecutive subframes.

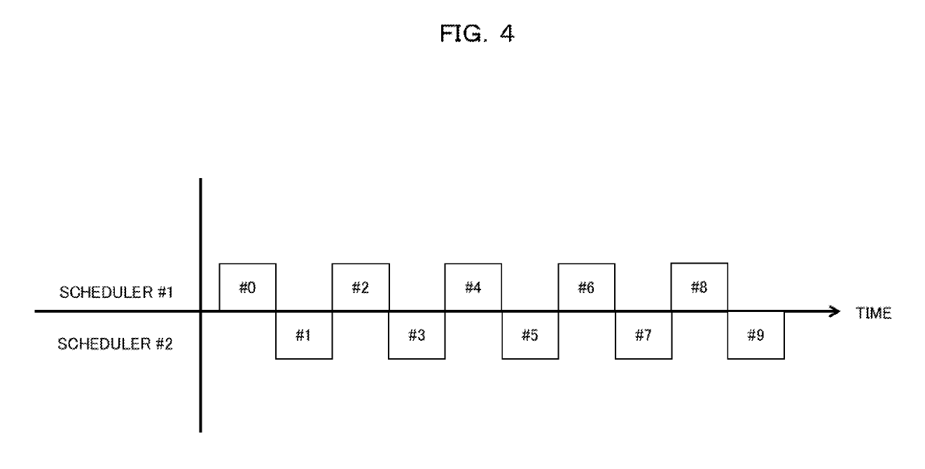

FIG. 4 illustrates a state in which the controller 205 controls operations of the schedulers #1 (204#1) and #2 (204#2). The schedulers #1 (204#1) and #2 (204#2) switch their operations each time a subframe elapses and operate in a time division manner. As an example of an operation in a time division manner, the scheduler #1 (204#1) processes an allocation of radio resources in even-numbered subframes #0, #2, #4, #6 and #8 in one frame. Further, the scheduler #2 (204#2) processes an allocation of radio resources in odd-numbered subframes #1, #3, #5, #7 and #9 in one frame. Thus, the controller 205 performs control such that the TTI which the scheduler #1 (204#1) processes and the TTI which the scheduler #2 (204#2) processes are alternately arranged on a time axis. In other words, the scheduler #1 (204#1) and the scheduler #2 (204#2) perform the radio resource allocation processes in a time division manner.

Since the scheduler #1 (204#1) and the scheduler #2 (204#2) perform the radio resource allocation processes in a time division manner, contention of an allocation of the same radio resources can be prevented. The scheduler #1 (204#1) and the scheduler #2 (204#2) need not be switched each time a subframe elapses. For example, the scheduler #1 (204#1) processes an allocation of radio resources in subframes #0, #1, #2, #3, and #4, and the scheduler #2 (204#2) processes an allocation of radio resources in subframes #5, #6, #7, #8, and #9. Further, the scheduler #1 (204#1) may perform an allocation of radio resources in a certain frame, and the scheduler #2 (204#2) may perform an allocation of radio resources in a subsequent frame.

In the above example, the number of subframes, in which the scheduler #1 (204#1) processes the allocation of radio resources in one frame, is the same as the number of subframes, in which the scheduler #2 (204#2) processes the allocation of radio resources in the frame. It is because the terminals 103#1 and 103#2 are assumed to perform initiation of communication with the base station 101 randomly. Since the terminals 103#1 and 103#2 initiate communication with the base station 101 randomly, the scheduler #1 (204#1) and the scheduler #2 (204#2) are considered to be responsible for the same number of terminals which is an average of the number of terminals for a sufficiently long period of time.

The controller 205 may change the terminals which the schedulers #1 (204#1) and #2 (204#2) are responsible for. In other words, the controller 205 can transfer a parameter related to an allocation of radio resources to the terminal which the scheduler is responsible for to another scheduler and set the parameter in another scheduler, and thus another scheduler is responsible for the terminal. This function will be described later as a function of the fourth processor 209.

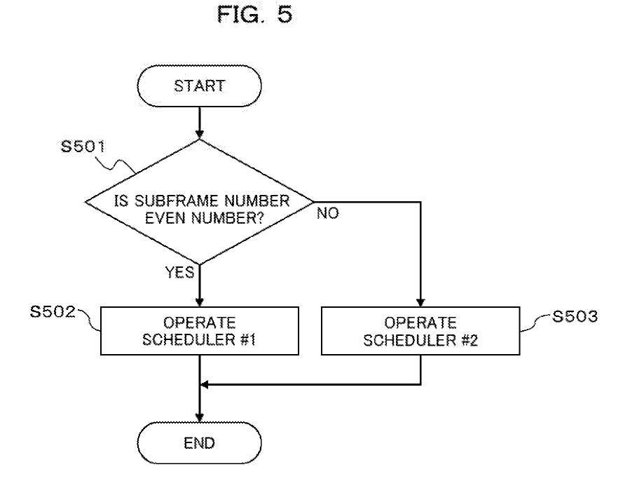

FIG. 5 illustrates an example of a flowchart of a process in which the base station 101 operates the schedulers #1 (204#1) and #2 (204#2). In step S501, the controller 205 determines whether or not a current subframe number is an even number. When a current subframe number is an even number, the controller 205 causes the process to proceed from step S501 through a “YES” route, and in step S502, the controller 205 operates the scheduler #1 (204#1) to perform an allocation of radio resources. When a current subframe number is not an even number, the controller 205 causes the process to proceed from step S501 through a “NO” route, and in step S503, the controller 205 operates the scheduler #2 (204#2) to perform an allocation of radio resources.

When N represents the number of schedulers, a variable n representing a scheduler number of a scheduler to be operated is prepared. As an initialization process, 1 is substituted into n, and each time a subframe elapses, the scheduler #n is operated to perform an allocation of radio resources and the value of the variable n is set to be a value obtained by adding 1 to a remainder obtained by dividing the value of the variable n by N. As the scheduler is operated as described above, sets of subframe numbers for which the respective schedulers allocate radio resources have no common number, and thus contention (in other words, conflict, collision, or competition) of radio resources can be prevented. Since a set of subframe numbers for which each scheduler allocates radio resources is a set of subframe numbers in one frame, it is possible to prevent a subframe to which radio resources are not allocated.

As described above, according to the first embodiment, a plurality of schedulers are responsible for different terminals and allocate radio resources at different TTIs, and thus contention of radio resources can be prevented. The scheduler can perform other processes at the TTI at which an allocation of radio resources is not performed. For example, as will be described later, it is possible to determine a terminal whose parameter is to be transferred to another scheduler and distribute a load.

### Second Embodiment

There are cases in which when the number of schedulers and the number of subframes in one frame are not relatively prime numbers, a set of subframe numbers for which an allocation of radio resources is performed in one frame is merely some of subframe numbers in one frame. The number of schedulers and the number of subframes in one frame not being relatively prime number corresponds to the case where 1 and −1 as an integer can only divide both of the number of schedulers and the number of subframes in one frame. In this case, the scheduler is allowed to allocate radio resources only for certain subframe numbers. For example, in the process illustrated in FIG. 5, the scheduler #1 (204#1) is allowed to perform an allocation of radio resources in even-numbered subframes but not allowed to perform an allocation of radio resources in odd-numbered subframes.

In this regard, the controller 205 may perform a process of switching a subframe number for which the scheduler #1 (204#1) performs an allocation of radio resources and a subframe number for which the scheduler #2 (204#2) performs an allocation of radio resources after an appropriate period of time (for example, 20 ms which is a packet interval of common voice communication) elapses. This process may also be referred to as a “processing TTI inversion process.” Through the processing TTI inversion process, the process that can be performed only in the even-numbered subframes can be performed by the scheduler #2 (204#2), and the process that can be performed only in the odd-numbered subframes can be performed by the scheduler #1 (204#1). In the controller 205, a part that performs the processing TTI inversion process is also referred to as the first processor 206. In the present embodiment, the second processor 207, the third processor 208, and the fourth processor 209 are not mandatory components.

For example, an inversion flag may be used to switch a subframe number for which the scheduler #1 (204#1) performs an allocation of radio resources and a subframe number for which the scheduler #2 (204#2) performs an allocation of radio resources. For example, the first processor 206 changes a value of the inversion flag each time a predetermined period of time elapses. For example, the inversion flag may be a variable having values of ON and OFF.

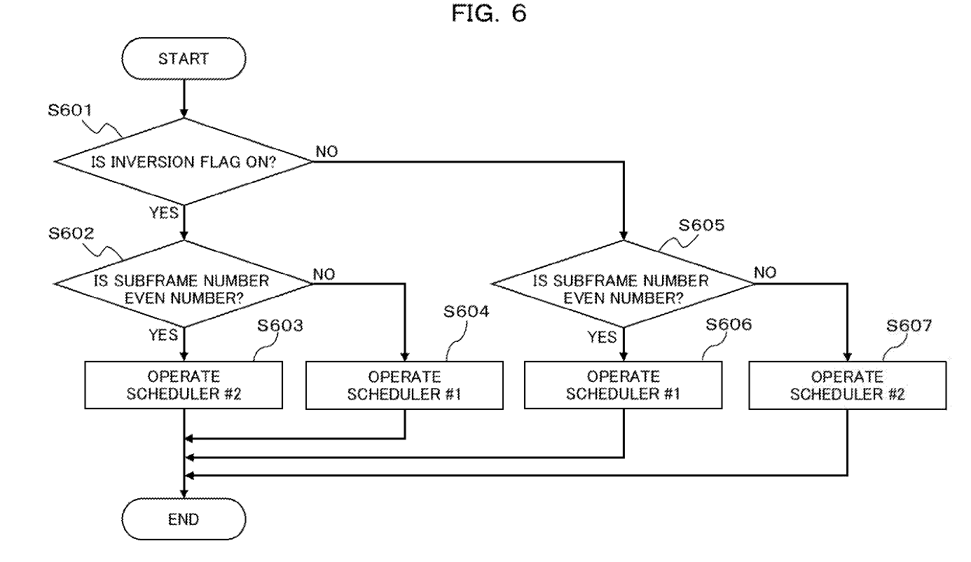

FIG. 6 illustrates an example of a flowchart of a process in which the base station 101 operates the schedulers #1 (204#1) and #2 (204#2) when the inversion flag is used.

In step S601, the controller 205 determines whether or not the value of the inversion flag is ON. When the value of the inversion flag is ON, the controller 205 causes a process to proceed through a “YES” route to step S602, but when the value of the inversion flag is OFF, the controller 205 causes a process to proceed through a “NO” route to step S605.

In step S602 and step S605, the controller 205 determines whether or not a current subframe number is an even number. When a current subframe number is an even number, the controller 205 causes a process to proceed from step S602 and step S605 through a “YES” route to step S603 and S606, respectively. When a current subframe number is an odd number, the controller 205 causes a process to proceed from step S602 and step S605 through a “NO” route to step S604 and step S607, respectively.

In step S603, the controller 205 causes the scheduler #2 (204#2) to perform an allocation of radio resources. In step S604, the controller 205 causes the scheduler #1 (204#1) to perform an allocation of radio resources. Thus, when the inversion flag is ON, the scheduler #2 (204#2) performs an allocation of radio resources in the even-numbered subframes, and the scheduler #1 (204#1) performs an allocation of radio resources in the odd-numbered subframes.

In step S606, the controller 205 causes the scheduler #1 (204#1) to perform an allocation of radio resources. In step S607, the controller 205 causes the scheduler #2 (204#2) to perform an allocation of radio resources. Thus, when the inversion flag is OFF, the scheduler #1 (204#1) performs an allocation of radio resources in the even-numbered subframes, and the scheduler #2 (204#2) performs an allocation of radio resources in the odd-numbered subframes.

As described above, in the present embodiment, when a sufficient long period of time elapses, the scheduler performs an allocation of radio resources in subframes of all subframe numbers in a frame. Thus, the base station can provide a service that can be provided only by using all subframe numbers.

### Third Embodiment

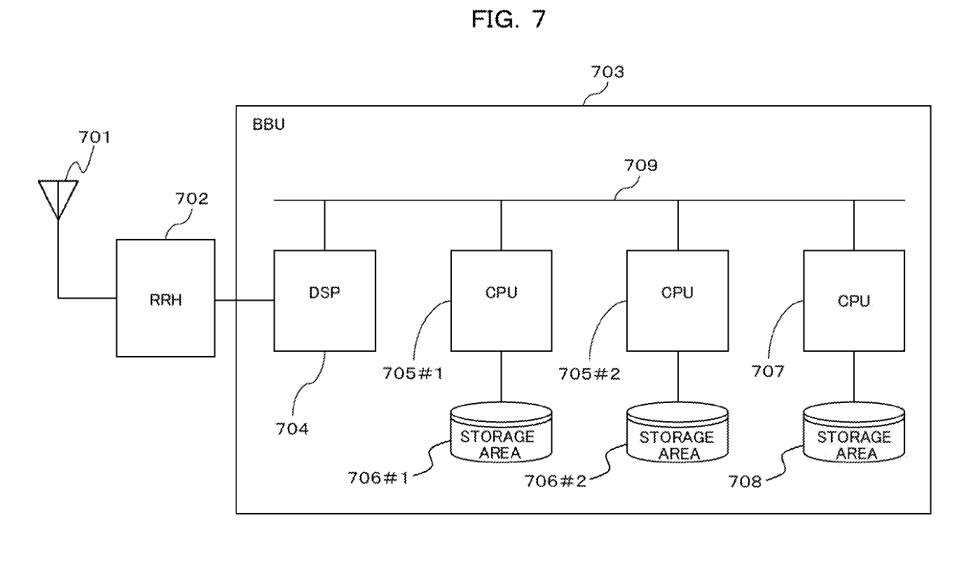

FIG. 7 is a diagram illustrating a hardware configuration of the RF processor 201 and the communication processor 202 in the base station 101. The RF processor 201 and the communication processor 202 as hardware includes an antenna 701, a remote radio head (RRH) 702, and a base band unit (BBU) 703.

The antenna 701 radiates a transmission signal into a space as a wireless signal, and acquires a wireless signal in a space and converts the wireless signal into a reception signal.

The RRH 702 is connected with the antenna 701 and the BBU 703, converts a baseband signal output from the BBU 703 into a transmission signal and outputs the transmission signal to the antenna 701, and converts a reception signal output from the antenna into a baseband signal and outputs the baseband signal to the BBU 703. The RRH can mainly perform the process of the RF processor 201.

The BBU 703 includes a digital signal processor (DSP) 704, CPUs 705#1 and 705#2, storage areas 706#1 and 706#2, a CPU 707, and a storage area 708. The BBU 703 can mainly perform the processes of the communication processor 202, the schedulers #1 (204#1) and #2 (204#2), and the controller 205. The BBU 703 may be configured to perform the process of the line terminator 203.

The DSP 704 is a digital signal processor that receives or outputs the baseband signal from or to the RRH 702. The DSP 704 may be configured with a field programmable gate array (FPGA). A function of the DSP 704 can be provided by executing a program.

The CPUs 705#1 and 705#2 provide the functions of the schedulers #1 (204#1) and #2 (204#2) by executing programs stored in the storage areas 706#1 and 706#2. The storage areas 706#1 and 706#2 can provide a work area in which the CPUs 705#1 and 705#2 execute the programs.

The CPU 707 provides the function of the controller 205 by executing a program stored in the storage area 708. The storage area 708 can provide a work area with which the CPU 707 executes the program.

The functions of the schedulers #1 (204#1) and #2 (204#2) can be provided by executing the programs through the CPUs 705#1 and 705#2 but may be provided by a hardware configuration such as an FPGA. The function of the controller 205 may be provided by a hardware configuration such as an FPGA.

The CPU 707 executes the program and provides the function of the controller 205. Accordingly, the controller 205 can perform transmission and reception of control data with the scheduler #1 (204#1) and the scheduler #2 (204#2) which are provided by execution of the programs by the CPUs 705#1 and 705#2. The CPUs 705#1 and 705#2 can perform transmission and reception of control data with the DSP 704 via a bus 709 and allocate radio resources to the terminals 103#1 and 103#2.

### Fourth Embodiment

The numbers of terminals which the respective schedulers are responsible for may be different from each other. In this case, as an embodiment, a countermeasure against the case where the numbers of terminals which the respective schedulers are responsible for are different from each other will be described.

When the numbers of terminals which the respective schedulers are responsible for are different from each other, and the numbers of terminals which the respective schedulers are responsible for are unbalanced, a load of a certain scheduler may be increased, and communication may be delayed. In this regard, the second processor 207 changes a total duration of subframes in one frame in which a scheduler performs an allocation of radio resources according to the number of terminals which the scheduler is responsible for. For example, each of the scheduler #1 (204#1) and the scheduler #2 (204#2) is assumed to perform an allocation of radio resources in a duration of 50% of one frame (50% of a total duration). In this state, when the number of terminals which the scheduler #1 (204#1) is responsible for is 100, and the number of terminals which the scheduler #2 (204#2) is responsible for is 400, the load of the scheduler #2 (204#2) is high.

In this regard, the second processor 207 causes the scheduler #1 (204#1) to perform an allocation of radio resources in a period of time of 20% of the total duration of one frame. The second processor 207 causes the scheduler #2 (204#2) to perform an allocation of radio resources in a period of time of 80% of the total duration of one frame. Accordingly, the load of the scheduler #2 (204#2) can be prevented from being increased to be higher than those of the other schedulers.

The third processor 208 changes the total duration in which the scheduler performs an allocation of radio resources in one frame by changing the number of subframes. The number of terminals which the scheduler #1 (204#1) is responsible for is assumed to be 100, and the number of terminals which the scheduler #2 (204#2) is responsible for is assumed to be 400. In this case, the third processor 208 causes the scheduler #1 (204#1) to perform an allocation of radio resources in two subframes among ten subframes in one frame. The third processor 208 causes the scheduler #2 (204#2) to perform an allocation of radio resources in eight subframes.

A functional block diagram and a hardware configuration diagram of the base station of the present embodiment may be the same as in the first embodiment. As will be described below, the processes of the controller 205, the scheduler #1 (204#1), and the scheduler #2 (204#2) are added to that in the first embodiment.

The controller 205 may be equipped with either or both of the second processor 207 and the third processor 208. In the present embodiment, the first processor 206 and the fourth processor 209 are not mandatory components.

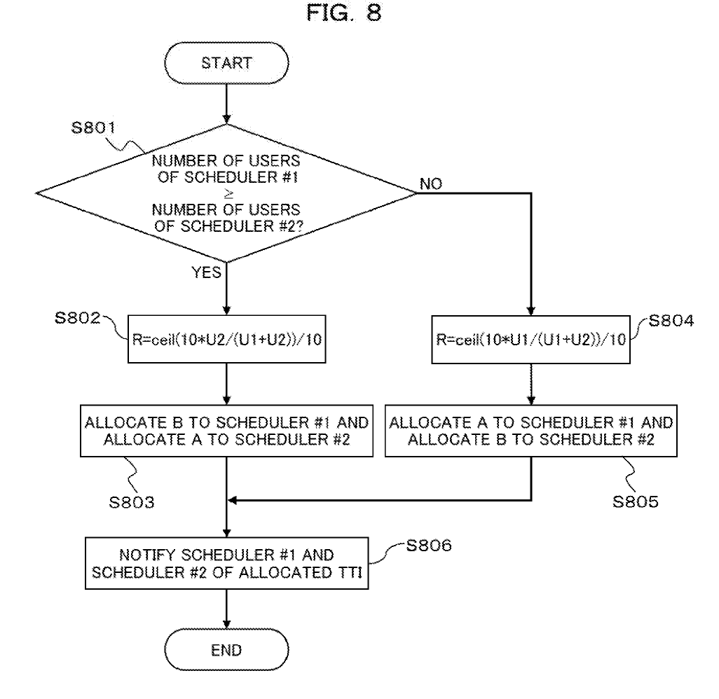

FIG. 8 is a flowchart illustrating a process of the controller 205 according to the present embodiment. In step S801, the controller 205 compares the number of users of the scheduler #1 (204#1) with the number of users of the scheduler #2 (204#2). The number of users of the scheduler #1 (204#1) indicates the number of terminals which the scheduler #1 (204#1) is responsible for. Similarly, the number of users of the scheduler #2 (204#2) indicates the number of terminals which the scheduler #2 (204#2) is responsible for.

When the number of users of the scheduler #1 (204#1) is the number of users of the scheduler #2 (204#2) or larger, the controller 205 causes a process to proceed from step S801 through a “YES” route to step S802. When the number of users of the scheduler #1 (204#1) is less than the number of users of the scheduler #2 (204#2), the controller 205 causes a process to proceed from step S801 through a “NO” route to step S804.

In step S802, the controller 205 substitutes ceil(10*U2/(U1+U2))/10 into a variable R. Here, ceil(x) is the smallest integer greater than x, and U1 and U2 indicate the number of users of the scheduler #1 (204#1) and the number of users of the scheduler #2 (204#2), respectively. In step S802, since U1≧#U2, a value of R is any one of 0.1, 0.2, 0.3, 0.4, and 0.5.

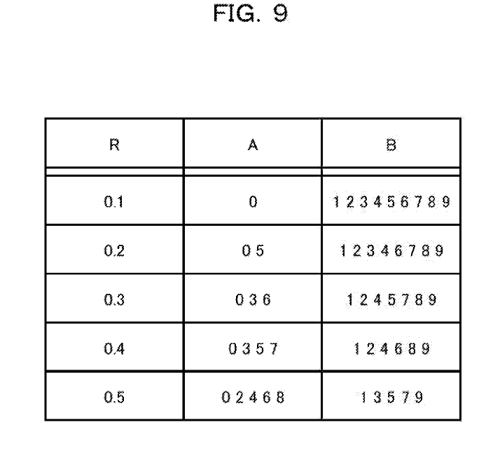

After step S802, the controller 205 causes the process to proceed to step S803, and the controller 205 allocates B to the scheduler #1 (204#1), ad allocates A to the scheduler #2 (204#2). The allocation of A and the allocation of B indicate subframe numbers (also referred to as “processing TTIs”) for which the scheduler #1 (204#1) and the scheduler #2 (204#2) perform allocations of radio resources, and an example thereof is illustrated in FIG. 9.

FIG. 9 illustrates a table in which A serving as one or more processing TTIs and B serving as other processing TTIs are associated with 0.1, 0.2, 0.3, 0.4, and 0.5 serving as a value of R. For example, when R is 0.1, the processing TTI of A is 0, and the processing TTIs of B are 1, 2, 3, 4, 5, 6, 7, 8, and 9. Thus, when R is 0.1, in the process of step S803, 0 which indicates the processing TTI of A is allocated to the scheduler #2 (204#2). Further, when R is 0.1, in the process of step S803, 1, 2, 3, 4, 5, 6, 7, 8, and 9 which indicate the processing TTIs of B are allocated to the scheduler #1 (204#1). Thus, the number of subframes corresponding to a length which is 0.1 times of a duration of one frame (in other words, a frame duration) among the frame duration is allocated to the scheduler #2 (204#2).

This applies when R is 0.2, 0.3, 0.4, or 0.5, similarly to when R is 0.1.

After step S803, the controller 205 causes the process to proceed to step S806, and the controller 205 notifies the scheduler #1 (204#1) and the scheduler #2 (204#2) of the processing TTI allocated in step S803.

In step S804, inversely with step S802, U2>U1, and the controller 205 substitutes ceil(10*U1/(U1+U2))/10 into the variable R. A value of R is any one of 0.1, 0.2, 0.3, and 0.4.

After step S804, the controller 205 causes the process to proceed to step S805, and the controller 205 allocates the processing TTI of A to the scheduler #1 (204#1), and allocates the processing TTI of B to the scheduler #2 (204#2).

After step S805, the controller 205 causes the process to proceed to step S806, the controller 205 notifies the scheduler #1 (204#1) and the scheduler #2 (204#2) of the processing TTI allocated in step S805.

As described above, in an embodiment, a duration or the number of subframes in which an allocation of radio resources is performed is adjusted according to the number of users of the scheduler. Accordingly, even when the numbers of users of the schedulers are unbalanced, the processing TTI of the scheduler is adjusted, and data can be prevented from being delayed.

### Fifth Embodiment

As an embodiment, an embodiment in which the number of users of the scheduler is changed will be described. For example, an embodiment in which the parameter related to an allocation of radio resources to the terminal which the scheduler #1 (204#1) is responsible for is transferred to the scheduler #2 (204#2) will be described. As a result, the scheduler #2 (204#2) is responsible for the terminal which the scheduler #1 (204#1) has been responsible for, and the responsible scheduler is changed. The process of changing the responsible scheduler is performed by the fourth processor 209.

The base station of the present embodiment has a similar configuration to any one of those of the first to fourth embodiments. In the present embodiment, the first processor 206, the second processor 207, and the third processor 208 are not mandatory components.

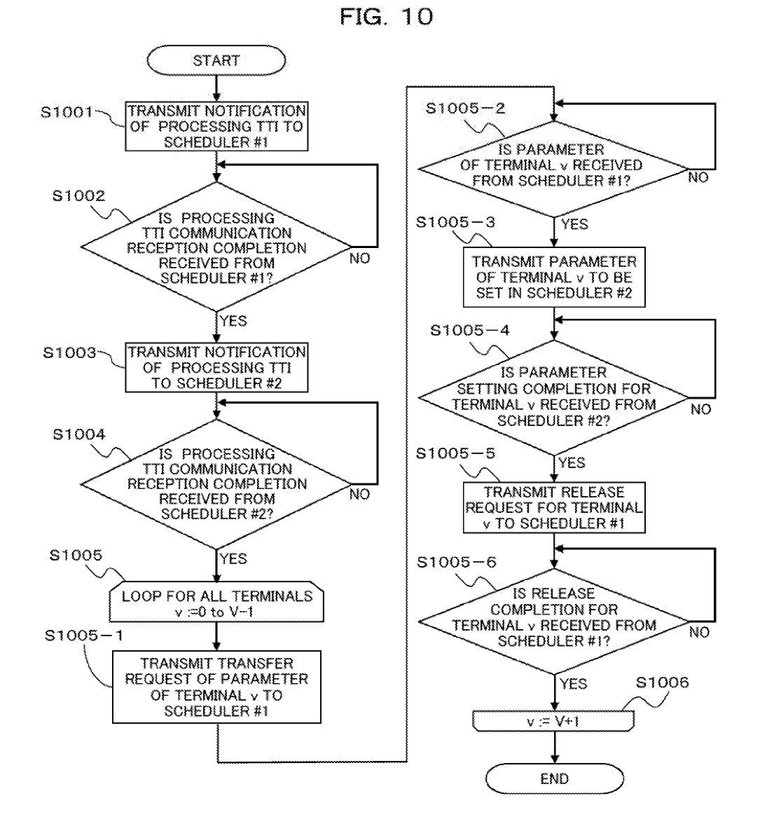

FIG. 10 is a flowchart illustrating a process of the fourth processor 209 according to the present embodiment.

In step S1001, the fourth processor 209 gives a notification of the processing TTI to the scheduler #1 (204#1). This notification is given as described above, for example, with reference to FIGS. 8 and 9. This notification is given when the fourth processor 209 makes a decision of transferring the parameter related to the allocation of radio resources to the terminal from the scheduler #1 (204#1) to the scheduler #2 (204#2).

With the decision of transferring the parameter related to the allocation of radio resources, a notification of the processing TTI may be given based on the number of terminals which each scheduler is responsible for after the transfer or may be given based on an anticipated average value of the number of terminals which each scheduler is responsible for during the transfer. Accordingly, the delay after or during movement of a plurality of terminals can be prevented.

After step S1001, in step S1002, the fourth processor 209 enters a standby state, for example, by causing the process to proceed through a “NO” route until response information indicating that the scheduler #1 (204#1) completes reception of the notification of the processing TTI is received (in other words, processing TTI communication reception completion reception is performed). Upon receiving the response information indicating that the reception of the notification of the processing TTI is completed, the fourth processor 209 causes the process to proceed through a “YES” route to step S1003.

In step S1003, the fourth processor 209 transmits the notification of the processing TTI to the scheduler #2 (204#2). For example, if R is 0.2 when B is allocated to the scheduler #2 (204#2), 1, 2, 3, 4, 6, 7, 8, and 9 are notified of as the processing TTIs.

After step S1003, in step S1004, the fourth processor 209 enters the standby state, for example, by causing the process to proceed through a “NO” route until response information indicating that the scheduler #2 (204#2) completes reception of the notification of the processing TTI is received (in other words, processing TTI communication reception completion reception is performed). Upon receiving the response information indicating that the reception of the notification of the processing TTI is completed, the fourth processor 209 causes the process to proceed through a “YES” route to step S1005.

A process from step S1005 to step S1006 is a loop, and the number V of times the loop is performed is the number of numbers 0 to V−1 of moving terminals.

In step S1005-1, the fourth processor 209 transmits a transfer request of a parameter of a terminal v (in other words, a terminal whose number is a value of a variable v) (in other words, performs transfer request transmission) to the scheduler #1 (204#1).

Then, in step S1005-2, the fourth processor 209 enters the standby state, for example, by causing the process to proceed through a “NO” route until the parameter of the terminal v is received from the scheduler #1. Upon receiving the parameter of the terminal v, the controller 205 causes the process to proceed through “YES” route to step S1005-3.

In step S1005-3, the fourth processor 209 transmits the parameter of the terminal v (in other words, performs parameter setting transmission in order to set the parameter of the terminal v in the scheduler #2.

Then, in step S1005-4, the fourth processor 209 enters the standby state, for example, by causing the process to proceed through a “NO” route until response information indicating that the setting of the parameter of the terminal v is completed is received from the scheduler #2 (in other words, parameter setting completion reception is performed). Upon receiving the response information, the fourth processor 209 causes a process to proceed through a “YES” route to step S1005-5.

In step S1005-5, the fourth processor 209 transmits a release request for the terminal v to the scheduler #1 (204#1) (in other words, performs release request transmission).

Then, in step S1005-6, the fourth processor 209 enters the standby state, for example, by causing the process to proceed through a “NO” route until response information indicating that the release of the terminal v is completed is received from the scheduler #1 (240#1) (in other words, release completion reception is performed). Upon receiving the response information, the fourth processor 209 causes the process to proceed through a “YES” route to step S1006.

As described above, in an embodiment, it is possible to transfer the parameter of the terminal between the schedulers. For example, it is possible to transfer the parameter of the terminal from an existing scheduler to a scheduler added when the scheduler is newly added, and it is possible to distribute the load of the scheduler. Further, when a certain scheduler has a failure, it is possible to transfer the parameter of the terminal from the scheduler having the failure to a scheduler having no failure and continue the allocation of radio resources.

### Sixth Embodiment

A process of the scheduler according to a sixth embodiment will be described.

There are several schemes as a scheduling scheme of the scheduler. In the present embodiment, a scheme of comparing metrics of terminals and selecting a terminal having the largest metric will be described as an example.

The scheduling process is roughly divided into three phases. In a first phase, the scheduler selects terminals of a scheduling target, for example, based on the presence or absence of data to be transmitted in the respective terminals. In a second phase, the scheduler calculates a scheduling metric serving as a scheduling priority for the terminal selected in the first phase. In a third phase, the scheduler compares the scheduling metrics of the terminals calculated in the second phase and finally determines a terminal of the scheduling target.

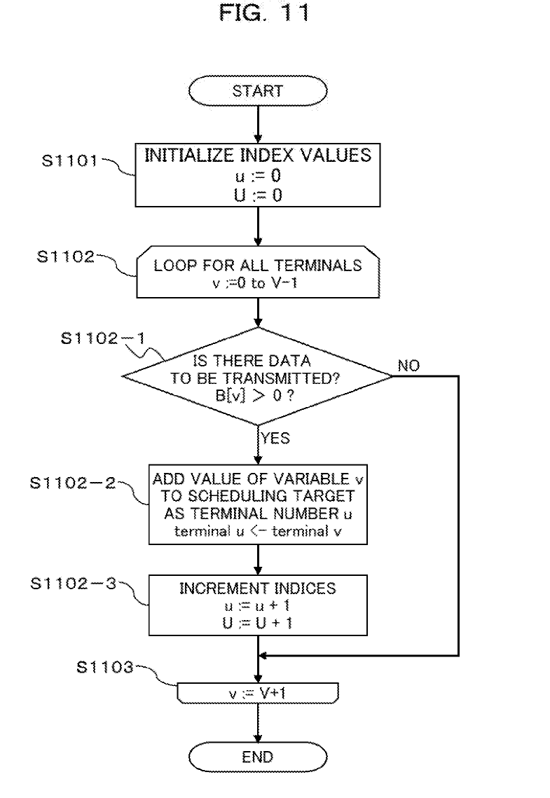

FIG. 11 is a flowchart illustrating a process of selecting the terminals of the scheduling target in the first phase. In this process, among all terminals, terminals whose buffer state B[v] is larger than 0 due to the presence of data to be transmitted are searched for. Consecutive indices are allocated to the searched users for the process in the second phase.

In step S1101, the scheduler initializes variables u and U indicating indices. Then, a process of step S1102 and step S1103 is a loop performed for all terminals.

In step S1102-1, the scheduler determines whether or not the buffer state B[v] is larger than 0. The buffer state of the terminal is an indicator that is larger than 0 when there is data to be transmitted to or to be received from the terminal. When the buffer state B[v] is larger than 0, the scheduler causes the process to proceed through a “YES” route to step S1102-2. When the buffer state B[v] is 0, the scheduler skips the process until step S1103.

In step S1102-2, the scheduler adds the value of the variable v as the index for the terminal of the scheduling target. Then, in step S1102-3, the scheduler increments the indices u and U by 1.

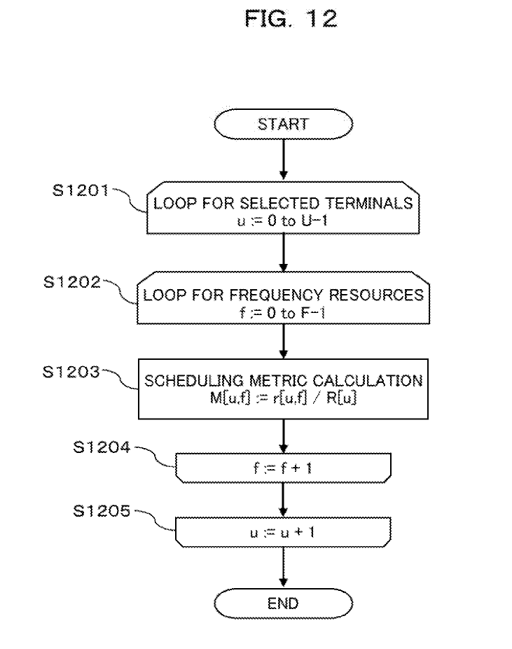

FIG. 12 is a flowchart illustrating a process of calculating a scheduling metric for the terminal of the scheduling target in the second phase. In other words, a scheduling metric calculation is performed on all the terminals selected as the scheduling target in FIG. 11.

In a process from step S1201 to S1205, the scheduler performs a loop for the terminals selected as the scheduling target.

In a process of steps S1202 to S1204, the scheduler performs a loop for frequency resources for one terminal selected as the scheduling target, and performs the scheduling metric calculation. Various methods can be understood as a scheduling metric calculation method, and in step S1203, for example, the scheduler calculates a metric using a proportional fairness method. In other words, the scheduler calculates M[u,f]=r[u,f]/R[u]. Here, r[u,f] is an instant data rate in a frequency resource f of a terminal u (a transmission data rate estimated from a wireless quality of the terminal and the frequency resource), and R[u] is an average data rate of the terminal u.

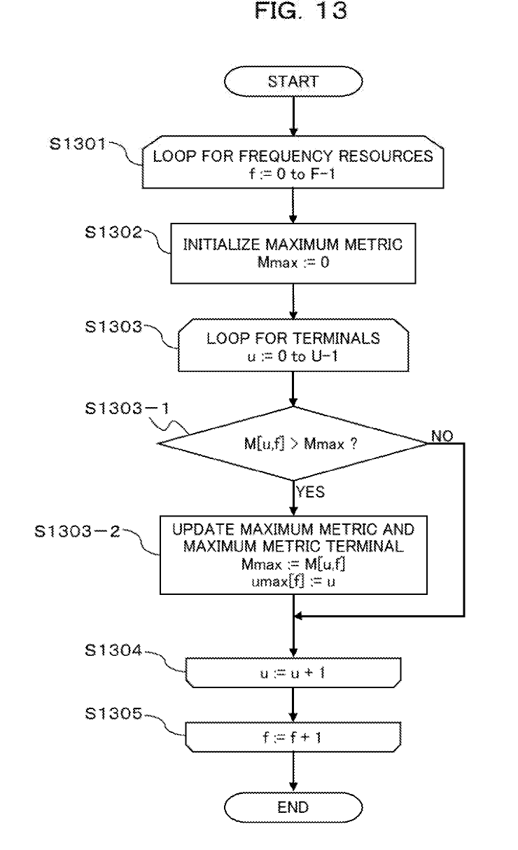

FIG. 13 is a flowchart in the third phase. The scheduler compares the scheduling metrics which are calculated in the second phase for all the terminals of the scheduling target for every frequency resource, and determines a terminal having the largest scheduling metric as a scheduling terminal of the frequency resource.

A process from step S1301 to step S1305 is a loop performed for every frequency resource. In step S1302, the scheduler initializes a maximum metric Mmax to 0.

Then, in a process from step S1303 to step S1304, the number U of times a loop is performed is the number of numbers 0 to U−1 of terminals.

In step S1303-1, the scheduler determines whether or not the metric M[u,f] is larger than Mmax. When the metric M[u,f] is larger than Mmax, the scheduler causes the process to proceed through a “YES” route to step S1303-2. When the metric M[u,f] is Mmax or less, the scheduler causes the process to proceed through a “NO” route and skip the process of step S1303-2.

In step S1303-2, the scheduler updates the maximum metric terminal. In other words, the scheduler sets a value of Mmax as M[u,f], and sets a value of umax[f] indicating a terminal having the maximum metric in the frequency resource f as u.

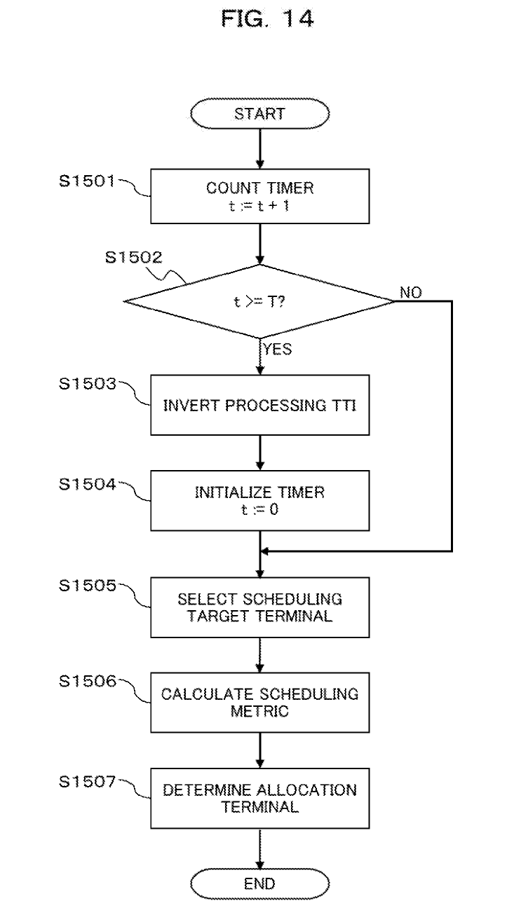

FIG. 14 is a flowchart illustrating a process in which a process of inverting the TTI of the first processor 206 is combined with a combination of the processes of the scheduler described above with reference to FIG. 11, FIG. 12, and FIG. 13. FIG. 14 is a flowchart illustrating a process of the first processor 206.

In step S1501, the first processor 206 increments a timer count t by 1. The timer count indicates the number of times the process of FIG. 14 is executed. The timer count is a variable used for determining a point in time at which the TTI is inverted.

Then, in step S1502, the first processor 206 determines whether or not a value of the timer count t is a constant T or more. The constant T indicates the number of times the process of FIG. 14 is executed until the TTI is inverted and is a constant corresponding to a duration in which the TTI is inverted. When a value of t is T or larger, the first processor 206 causes the process to proceed through a “YES” route and performs a process of step S1503 and S1504. When a value of t is smaller than T, the first processor 206 causes the process to proceed through a “NO” route and skip the process of step S1503 and S1504.

In step S1503, the first processor 206 inverts the processing TTI. For example, when there are two schedulers, the first processor 206 switches processing TTI times of the schedulers. Further, when there are three schedulers, the first processor 206 circularly switches the processing TTI times of the schedulers. For example, when current processing TTI times of the schedulers #a, #b, and #c are #A, #B, and #C, respectively, the first processor 206 switches the processing TTI times of the schedulers #a, #b, and #c to #B, #C, and #A, respectively.

In step S1504, the first processor 206 initializes the timer count t by substituting 0 into the timer count t.

Then, in step S1505, the scheduler selects the scheduling target terminal according to, for example, the flowchart of FIG. 11.

Then, in step S1506, the scheduler performs the scheduling metric calculation according to, for example, the flowchart of FIG. 12.

Then, in step S1507, the scheduler determines the terminal to which radio resources are allocated according to, for example, the flowchart of FIG. 13.

### Seventh Embodiment

An example in which the base station is implemented using a virtual machine (VM) will be described as a seventh embodiment. The use of the VM is a technique of expressing, for example, a virtual CPU, a virtual storage area, and a virtual DSP as a process operating in a computer by virtualizing hardware resources such as a CPU, a storage area, and a DSP. By allocating actual hardware resources to the process, virtualized hardware operates.

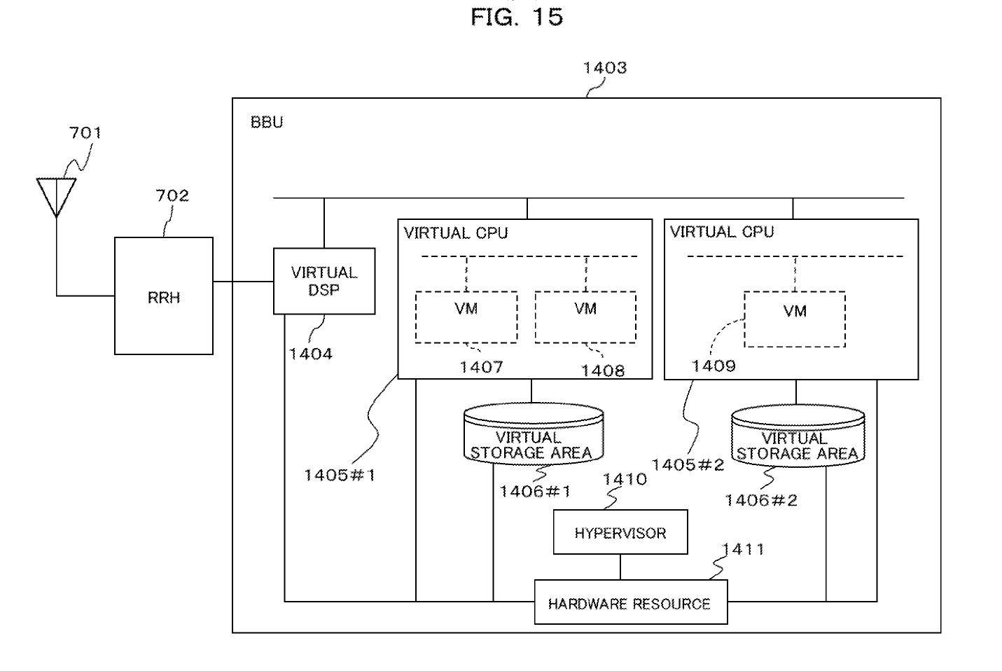

FIG. 15 is a functional block diagram of a baseband unit 1403 when the baseband unit 703 illustrated in FIG. 7 is implemented through virtualization of hardware.

The baseband unit 1403 includes a virtual CPU 1405#1, a virtual CPU 1405#2, a virtual storage area 1406#1, a virtual storage area 1406#2, and a virtual DSP 1404. Each of the virtual CPU 1405#1, the virtual CPU 1405#2, the virtual storage area 1406#1, the virtual storage area 1406#2, and the virtual DSP 1404 is implemented as a process operated by a CPU included in actual hardware resources 1411.

The virtual CPU 1405#1 operates VMs 1407 and 1408. Each of the VMs 1407 and 1408 is implemented as a process operated by the virtual CPU 1405#1. In FIG. 15, each of the VMs 1407 and 1408 provides the functions of the scheduler #1 (204#1) and the controller 205. Similarly, the VM 1409 is implemented as a process operated by the virtual CPU 1405#2. In FIG. 15, the VM 1409 provides the function of the scheduler #2 (204#2).

Each of the virtual storage areas 1406#1 and 1406#2 is connected with the virtual CPUs 1405#1 and 1405#2 and provide the storage areas to the VM 1407, 1408 and 1409 operated by the virtual CPUs 1405#1 and 1405#2.

The virtual DSP 1404 is an entity in which a CPU executing a program that provides the function of the DSP 704 is virtualized.

In FIG. 15, a hypervisor 1410 allocates the hardware resources 1411 to the virtual CPU 1405#1, the virtual CPU 1405#2, the virtual storage area 1406#1, the virtual storage area 1406#2, and the virtual DSP 1404. Thereby, each of the virtual CPU 1405#1, the virtual CPU 1405#2, the virtual storage area 1406#1, the virtual storage area 1406#2, and the virtual DSP 1404 operates.

Through the virtualization, a scheduler virtualized by addition of software can be added as necessary, and extendibility is increased. For example, even when the virtual CPU is in an idle state, actual hardware resources can be allocated to an operable CPU through the hypervisor, and usage efficiency of actual hardware can be increased.

### Comparative Examples

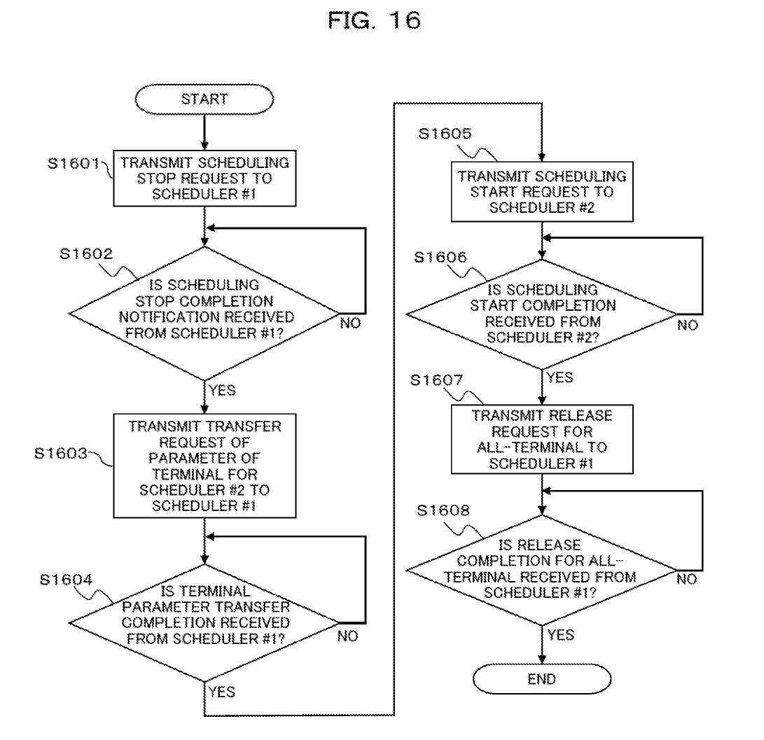

FIG. 16 is a flowchart illustrating a process of transferring the terminal from the scheduler #1 to the scheduler #2 according to a comparative example.

In step S1601, the controller transmits a scheduling stop request to the scheduler #1. Then, in step S1602, when a completion notification indicating that the scheduling is stopped is not received from the scheduler #1, the controller enters the standby state, for example, by causing the process to proceed through a “NO” route. When the completion notification indicating that the scheduling is stopped is received from the scheduler #1, the controller causes the process to proceed through a “YES” route to step S1603.

In step S1603, the controller requests the scheduler #1 to transfer the parameter of the terminal to the scheduler #2. Then, in step S1604, when a completion notification indicating that the transfer of the parameter of the terminal is completed is not received from the scheduler #1, the controller enters the standby state, for example, by causing the process to proceed through a “NO” route. When the completion notification indicating that the transfer of the parameter of the terminal is completed is received from the scheduler #1, the controller causes the process to proceed to step S1605.

In step S1605, the controller transmits a scheduling start request to the scheduler #2 for the terminal whose parameter is transferred. Then, in step S1606, when response information indicating that the scheduling is started is not received from the scheduler #2, the controller enters the standby state, for example, by causing the process to proceed through a “NO” route. When the response information indicating that the scheduling is started is received from the scheduler #2, the controller causes the process to proceed to step S1607.

In step S1607, the controller transmits a request for releasing the terminal whose parameter is transferred from the scheduling to the scheduler #1. Then, in step S1608, when response information indicating that the terminal is released from the scheduling is not received from the scheduler #1, the controller enters the standby state, for example, by causing the process to proceed through a “NO” route. When the response information indicating that the terminal is released from the scheduling is received from the scheduler #1, the controller causes the process to proceed through a “YES” route.

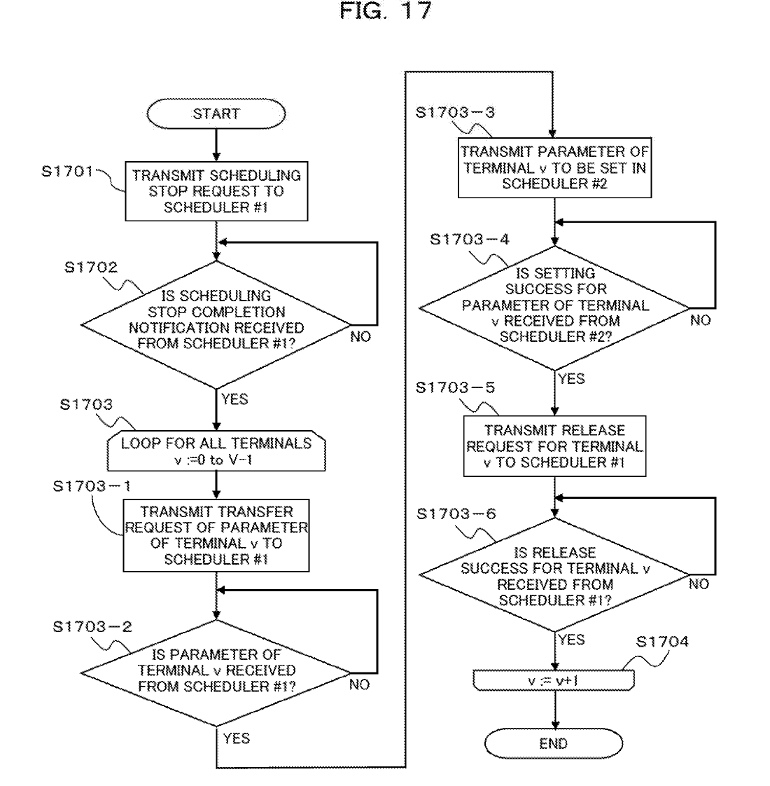

FIG. 17 is another flowchart illustrating a process of transferring the terminal from the scheduler #1 to the scheduler #2 according to a comparative example.

In step S1701, the controller transmits a scheduling stop request to the scheduler #1. Then, in step S1702, when a completion notification indicating that the scheduling is stopped is not received from the scheduler #1, the controller enters the standby state, for example, by causing the process to proceed through a “NO” route. When the completion notification indicating that the scheduling is stopped is received from the scheduler #1, the controller causes the process to proceed through a “YES” route to step S1703.

A process from step S1703 to step S1704 is a loop for the terminal v which is moved from the scheduler #1 to the scheduler #2.

In step S1703-1, the controller requests the scheduler #1 to transmit the parameter of the terminal v to the scheduler #2. Then, in step S1703-2, when the parameter of the terminal v is not received from the scheduler #1, the controller enters the standby state by causing the process to proceed through a “NO” route. When the parameter of the terminal v is received from the scheduler #1, the controller causes the process to proceed to step S1703-3.

In step S1703-3, the controller transmits the parameter of the terminal v to the scheduler #2. Then, in step S1703-4, when response information indicating that the parameter of the terminal v is set is not received from the scheduler #2, the controller enters the standby state by causing the process to proceed through a “NO” route. When the response information indicating that the parameter of the terminal v is set is received from the scheduler #2, the controller causes the process to proceed to step S1703-5.

In step S1703-5, the controller requests the scheduler #1 to release the terminal v to be released from the scheduling. Then, in step S1703-6, when response information indicating that the terminal v is released from the scheduling is not received from the scheduler #1, the controller enters the standby state by causing the process to proceed through a “NO” route. When the response information indicating that the terminal v is released from the scheduling is received from the scheduler #1, the controller causes the process to proceed through a “YES” route.

As described above, in the comparative examples, the controller requests the scheduler #1 to stop the scheduling as in step S1601 and step S1701. Thus, the scheduling by the scheduler #1 is stopped, and data is delayed.

On the other hand, in an embodiment of the disclosure, the scheduler can transfer the parameter of the terminal while performing scheduling of different processing TTIs. Accordingly, the delay of data can be prevented.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A base station, comprising:
a communication processor configured to perform a communication process;
a first scheduler configured to allocate radio resources to one or more first wireless communication terminals that perform wireless communication through the communication process of the communication processor;
a second scheduler configured to allocate radio resources to one or more second wireless communication terminals that perform wireless communication through the communication process of the communication processor; and
a controller configured to perform control such that a first time interval in which the first scheduler allocates the radio resources to the one or more of first wireless communication terminals is different from a second time interval in which the second scheduler allocates the radio resources to the one or more of second wireless communication terminals.

2. The base station according to claim 1,
wherein the controller performs control such that the first time interval and the second time interval are alternately arranged on a time axis.

3. The base station according to claim 2,
wherein each of subframes in one frame of the wireless communication through the communication process of the communication processor corresponds to the first time interval or the second time interval, and
the controller includes a first processor configured to perform switching subframe numbers corresponding to the first time interval in the one frame and subframe numbers corresponding to the second time interval in the one frame.

4. The base station according to claim 1,
wherein the controller includes a second processor configured to change a total length of the first time interval and a total length of the second time interval based on the number of the one or more first wireless communication terminals and the number of the one or more second wireless communication terminals.

5. The base station according to claim 1,
wherein each of subframes in one frame of the wireless communication through the communication process of the communication processor corresponds to the first time interval or the second time interval, and
the controller includes a third processor configured to change the number of subframes corresponding to the first time interval in the one frame and the number of subframes corresponding to the second time interval in the one frame based on the number of first wireless communication terminals and the number of second wireless communication terminals.

6. The base station according to claim 1,
wherein the controller includes a fourth processor configured to select one or more wireless communication terminals from the one or more first wireless communication terminals, causes the first scheduler to stop allocating the radio resources to the selected one or more wireless communication terminals, and causes the second scheduler to allocate the radio resources to the selected one or more wireless communication terminals.

7. A base station that performs communication with one or more wireless communication terminals belonging to a first group and one or more wireless communication terminals belonging to the second group, comprising:
a first scheduler configured to allocate radio resources to the one or more wireless communication terminals belonging to the first group;
a second scheduler configured to allocate radio resources to the one or more wireless communication terminals belonging to the second group; and
a controller configured to perform control such that a subframe for which the first scheduler allocates the radio resources is different from a subframe for which the second scheduler allocates the radio resources.

8. The base station according to claim 7,
wherein the controller controls the number of subframes for which the first scheduler allocates the radio resources in one frame and the number of subframes for which the second scheduler allocates the radio resources in the one frame based on the number of the one or more wireless communication terminals belonging to the first group and the number of the one or more wireless communication terminals belonging to the second group.

9. The base station according to claim 7,
wherein the controller performs control such that a set of subframe numbers for which the first scheduler allocates the radio resources in a plurality of frames is a first set of subframe numbers of one frame and performs control such that a set of subframe numbers for which the second scheduler allocates the radio resources in the plurality of frames is a second set of subframe numbers of the one frame, and a sum set of the first set and the second set is a set of subframe numbers in the one frame.

10. The base station according to claim 7,
wherein the controller selects one or more wireless communication terminals from the first group and sets the selected one or more wireless communication terminals to belong to the second group.

11. A scheduling method, comprising:
allocating radio resources to one or more first wireless communication terminals that perform wireless communication;
allocating radio resources to one or more second wireless communication terminals that perform wireless communication; and
performing control such that a first time interval in which the radio resources are allocated to the one or more first wireless communication terminals is different from a second time interval in which the radio resources are allocated to the one or more second wireless communication terminals.

12. The scheduling method according to claim 11,
wherein the control is performed such that the first time interval and the second time interval are alternately arranged on a time axis.

13. The scheduling method according to claim 12,
wherein each of subframes in one frame corresponds to the first time interval or the second time interval, the scheduling method comprising
switching a subframe number corresponding to the first time interval in the one frame and a subframe number corresponding to the second time interval in the one frame is performed.

14. The scheduling method according to claim 11, the scheduling method comprising
changing a length of the first time interval and a length of the second time interval based on the number of the one or more first wireless communication terminals and the number of the one or more second wireless communication terminals.

15. The scheduling method according to claim 11,
wherein each of subframes in one frame corresponds to the first time interval or the second time interval, the scheduling method comprising
changing the number of subframes corresponding to the first time interval in the one frame and the number of subframes corresponding to the second time interval in the one frame based on the number of the one or more first wireless communication terminals and the number of the one or more second wireless communication terminals.

16. The scheduling method according to claim 11, further comprising:
selecting a wireless communication terminal from the one or more first wireless communication terminals,
stopping allocating radio resources to the selected wireless communication terminal as belonging to the one or more first wireless communication terminals, and
allocating radio resources to the selected wireless communication terminal as belonging to the one or more second wireless communication terminals.
